(19) United States
(12) Patent Application Publication
(10) Pub. No.: US 2017/0010136 A1
(43) Pub. Date: Jan. 12, 2017

(54) LIGHT CONDUCTOR DEVICE FOR INDICATING LIGHT POINTER AND METER DEVICE INCLUDING THE SAME

(71) Applicants: DENSO International America, Inc., Southfield, MI (US); DENSO CORPORATION, Kariya-city (JP)

(72) Inventors: Jagadeesh Krishnamurthy, Troy, MI (US); Marc Arceo, Livonia, MI (US); Gareth Webb, Farmington, MI (US)

(21) Appl. No.: 14/793,803

(22) Filed: Jul. 8, 2015

(51) Int. Cl. G01D 11/28; F21V 8/00

(52) U.S. Cl. CPC G01D 11/28; G02B 6/0001

(57) ABSTRACT

A light conductor device receives light from a light source. The light conductor includes a radial conductor. The radial conductor includes a conductor body and a projection conductor. The conductor body has an annular end surface. The projection conductor has a projection surface. The conductor body is configured to receive light from the light source though the annular end surface. The conductor body is further configured to conduct the light in a radial direction to illuminate the projection surface in the radial direction and to form a light pointer on the projection surface.

### TECHNICAL FIELD

The present disclosure relates to a light conductor device for indicating a light pointer. The present disclosure further relates to a meter device including the light conductor device.

### BACKGROUND

A meter device is generally equipped in a vehicle for indicating information such as a vehicular speed and an engine revolution. A meter device may include a flat LCD screen to indicate various information. The flat LCD screen may be further desirable to have additional features.

### SUMMARY

According to an aspect of the present disclosure, a light conductor device may be configured to receive light from a light source. The light conductor device may comprise a radial conductor including a conductor body and a projection conductor. The conductor body may have an annular end surface. The projection conductor may have a projection surface. The conductor body may be configured to receive light from the light source though the annular end surface. The conductor body may be further configured to conduct the light in a radial direction to illuminate the projection surface in the radial direction and to form a light pointer on the projection surface.

### BRIEF DESCRIPTION OF THE DRAWINGS

The above and other objects, features and advantages of the present invention will become more apparent from the following detailed description made with reference to the accompanying drawings. In the drawings:

FIG. 1 is an exploded perspective view showing components of a meter device of a first embodiment;

FIG. 2 is a schematic sectional view showing the meter device;

FIG. 3 is an enlarged sectional view showing the meter device;

FIG. 4 is a perspective view showing the light conductor device mounted on the display;

FIG. 5 is a perspective view showing a part of the meter device;

FIG. 6 is a schematic sectional view showing a meter device of a second embodiment;

FIG. 7 is an enlarged sectional view showing the meter device of the second embodiment;

FIG. 8 is a perspective view showing a part of the meter device of the second embodiment;

FIG. 9 is a schematic sectional view showing a meter device of a third embodiment;

FIG. 10 is a perspective view showing a part of the meter device of the third embodiment;

FIG. 11 is a schematic sectional view showing a meter device of a fourth embodiment; and

FIG. 12 is a perspective view showing a part of the meter device of the fourth embodiment.

### DETAILED DESCRIPTION

### First Embodiment

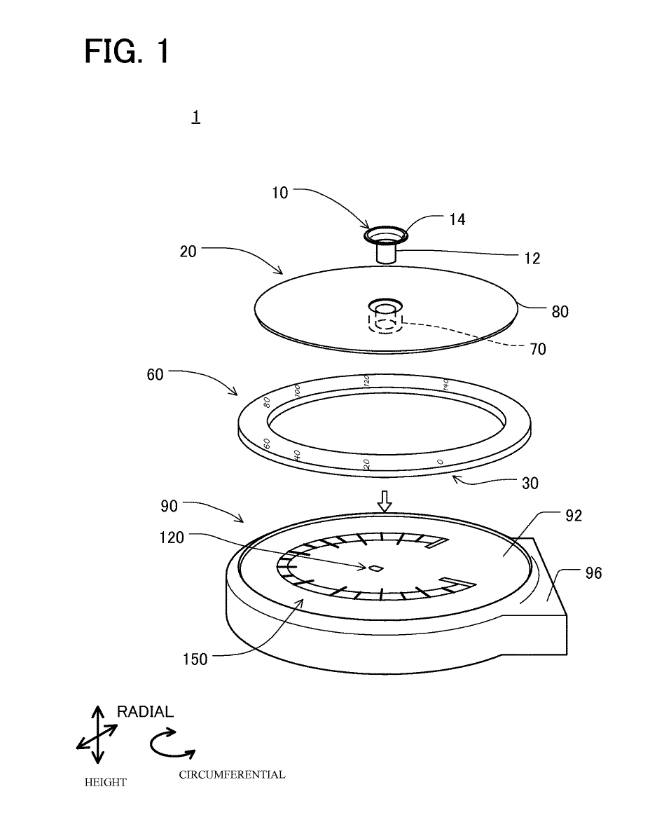

As shown in FIG. 1, a meter device 1 includes an opaque center 10, a radial conductor 20, a dial conductor 60, and a display device (light source) 90. The opaque center 10, the radial conductor 20, and the dial conductor 60 are coaxially stacked together and are mounted on the display device 90.

The opaque center 10 includes a center body 12 and a center disc 14, which are integrally molded of an opaque plastic material. The opaque plastic material may be ABS resin. The center body 12 is in a tubular shape extending in a height direction shown by “HEIGHT” in the drawing. The center body 12 has a conical top connected with the center disc 14. The center disc 14 is located on the outside of the conical top in a radial direction shown by “RADIAL” in the drawing. The center disc 14 is in a disc shape extending in a circumferential direction shown by “CIRCUMFERENTIAL” in the drawing. The center disc 14 is chamfered at its outer circumferential periphery to have a circular inclined surface faced upward in the drawing.

The radial conductor 20 is integrally molded of a substantially transparent light-conductive material. The substantially transparent light-conductive material may be acrylic resin (PMMA) or polycarbonate resin by, for example, injection molding. The radial conductor 20 includes an inner conductor body 70 and a conductor disc 80.

The inner conductor body 70 is in a tubular shape extending in the height direction. The inner conductor body 70 has a conical top connected with the conductor disc 80. The conductor disc (projection conductor) 80 is located on the outside of the conical top in the radial direction. The conductor disc 80 is in a disc shape extending in the circumferential direction. The conductor disc 80 is chamfered at its outer circumferential periphery to have a circular inclined surface faced downward in the drawing.

The dial conductor 60 is integrally molded of a substantially transparent light-conductive material. The dial conductor 60 is in a disc shape extending in the circumferential direction. The dial conductor 60 has letters (numeral symbols) 30 indicating information of the vehicle such as a vehicle speed, an engine revolution, a gear position, and/or the like.

The display device 90 is, for example, an LCD display or an organic EL display having a full-color dot-matrix configuration having multiple pixels, which are selectively activated. More specifically, the display device 90 may be an active matrix display such as a TFT LCD display and may have a lighting device to emit light to the screen 92. The display device 90 may be an organic EL display having a self-luminous configuration without an additional lighting device. The display device 90 is configured to indicate, for example, a full-color moving picture on a screen 92. In the example of FIG. 1, the display device 90 indicates a scale 150 and an inner pointer source 120.

The display device 90 includes a display body 96 accommodating a driver circuit for controlling activation of the pixels, the lighting device, and an I/O device. The I/O device may be connectable with an external circuit such as an ECU (electronic control device) of the vehicle to receive an electric power and to exchange graphic information related to the indicated picture with the ECU. The display device 90 may further include a microcomputer configured with a CPU and a storage device for processing the graphic information. In the present example, the screen 92 is in a circular shape, and the display body 96 is partially in a circular shape and has a base.

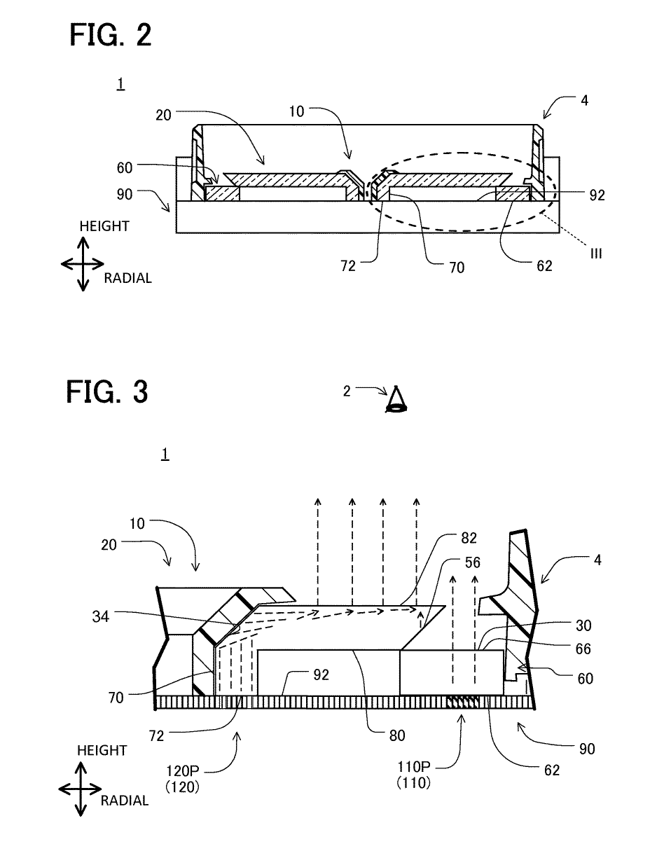

As shown in FIG. 2, the opaque center 10, the radial conductor 20, and the dial conductor 60 are stacked together and, for example, adhered on the display device 90. The radial conductor 20, and the dial conductor 60 are stationary (fixed) relative to the display device 90. A housing 4 is fixed to the display device 90 to house the opaque center 10, the radial conductor 20, and the dial conductor 60.

The inner conductor body 70 has an inner annular end surface 72 on the lower side. The inner annular end surface 72 is faced to the screen 92. The dial conductor 60 has an annular end surface 62 on the lower side. The annular end surface 62 is faced to the screen 92.

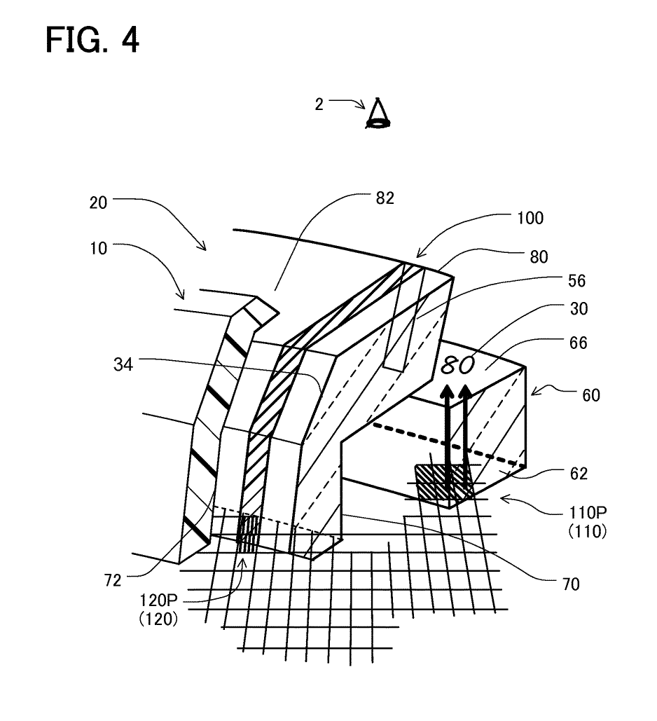

As follows, the configuration of the display device 90 will be described further in detail with reference to FIGS. 3 to 5. In FIGS. 3 and 4, the pixels are shown largely for explanation. In an actual configuration, the pixels may be much finer and may not be faced directly to the outside of the screen 92.

FIG. 3 shows one side of the meter device 1 encircled by III in FIG. 2. For convenience of explanation, the entire structure of the meter device 1 is reduced in width in the radial direction. Hatching is omitted in the radial conductor 20 and the dial conductor 60 in the FIG. 3.

The inner conductor body 70 has a receiver reflection surface 34 inclined relative to the inner annular end surface 72. The conductor disc 80 has an emitter reflection surface 56 inclined relative to the inner annular end surface 72. The receiver reflection surface 34 and the emitter reflection surface 56 are opposed to each other and may be substantially in parallel with each other. The conductor disc 80 has a disc projection surface 82 substantially in parallel with the inner annular end surface 72. The inner conductor body 70 and the conductor disc 80 form a bent light conduction passage. When viewed from a user 2 along the height direction, the inner annular end surface 72 is concealed by the opaque center 10.

The dial conductor 60 has a dial projection surface 66. The letters 30 may be printed and/or engraved on the dial projection surface 66. The dial conductor 60 may form a straight light conduction passage.

The display device 90 activates specific pixels. For example, each pixel may include red, green, and blue (RGB) pixel segments, and intensity of energization or de-energization of each of the RGB pixel segments may be selectively controlled to produce various combination of activated RGB pixel segments. Thus, each pixel is caused to produce luminescence (light) in various colors. As shown by differentiated hatchings and black fillings, the pixels emit lights in different colors selectively.

The display device 90 activates inner pointer source pixels 120P and letter illumination pixels 110P. The inner pointer source pixels 120P correspond to the inner pointer source 120. The letter illumination pixels 110P illuminate the letter 30.

The inner pointer source pixels 120P emit light (first light) along the dotted arrows through the inner conductor body 70 and the conductor disc 80. Specifically, the light incident from the inner pointer source pixels 120P passes through the inner conductor body 70 along the height direction. The light is reflected on the receiver reflection surface 34 and directed outward in the radial direction to pass through the conductor disc 80.

More specifically, the light includes light flux shown by the arrows. The light flux is reflected on the receiver reflection surface 34 and may be inflected at various angles. Thus, a portion of the light flux is directed linearly toward the disc projection surface 82 of the conductor disc 80. Thus, the portion of the light flux is directed linearly toward the disc projection surface 82 outward in the radial direction. Thus, the portion of the light flux illuminates the disc projection surface 82 to cause illumination viewed by the user 2. The illumination forms a light pointer 100 on the disc projection surface 82. The light pointer 100 linearly extends from the inner conductor body 70 radially outward and appears on the disc projection surface 82. The light pointer 100 may be in a needle shape and/or in a bar shape.

A portion of the light flux may be directed toward the emitter reflection surface 56 and reflected on the emitter reflection surface 56 thereby directed upward. In this way, the light flux incidents from the emitter reflection surface 56 through the disc projection surface 82.

The light incident from the conductor disc 80 is viewed as the light pointer 100 by the user 2. In this way, the light incident from the inner pointer source pixels 120P is emitted from the disc projection surface 82 linearly and continually at radially remote locations from the inner pointer source pixels 120P.

As shown by the two thin arrows, the letter illumination pixels 110P emit lights (second light) along the height direction through the dial conductor 60. Therefore, the light incident from the letter illumination pixels 110P passes through the letters 30 formed on the dial conductor 60 along the height direction thereby to illuminate the letters 30.

In the present configuration, the light pointer 100, which is shown on the disc projection surface 82, is viewable to be floating relative to the screen 92. The letters 30, which are formed on the dial projection surface 66 is illuminated to be floating relative to the screen 92. Thus, the radial conductor 20, the dial conductor 60, and the screen 92 form a multilayered illuminative structure to enhance its three-dimensional appearance.

The screen 92 may show a graphic image behind the light pointer. In this way, the light pointer may be overlapped with the graphic image on the screen.

As shown in FIG. 4, the display device 90 has the dot matrix configuration to enable activation of the pixels selectively. FIG. 4 shows the pixels coarsely, nevertheless, in an actual product of the display device 90, the pixels may be finely assigned to correspond substantially to the outlines of the inner annular end surface 72 and the annular end surface 62, and the outlines of the inner pointer source 120 and the letter 30. In the example, the inner pointer source pixels 120P and the letter illumination pixels 110P are described as being assigned at respective positions. It is noted that, those pixels are not fixed at respective positions and may be moved according to selective activation of pixels in the dot-matrix configuration.

The inner pointer source pixels 120P are arranged correspondingly to the shape of the inner annular end surface 72 of the dial conductor 60. The inner pointer source pixels 120P may form a sector shape, a rectangular shape, or a circular shape to control the shape and/or convergence (width) of the light pointer 100.

The light reflected on the receiver reflection surface 34 may be directed toward the emitter reflection surface 56 to show a rectangular highlight on the emitter reflection surface 56.

The conductor disc 80 extends from the inner conductor body 70 outward in the radial direction. Thus, the light reflected on the receiver reflection surface 34 is selectively directed linearly outward in the radial direction.

In the description, the intensity of the pixels may represent the light intensity of the pixels and/or the illumination color of the pixels.

The screen 92 is configured to manipulate the positions of the inner pointer source pixels 120P along the inner annular end surface 72 in the circumferential direction. For example, the positions of the inner pointer source pixels 120P is moved in the circumference direction clockwise, as the vehicle speed increases, when indicating the vehicle speed. Correspondingly, the light pointer 100 also moves clockwise on the disc projection surface 82 thereby to function similarly to a needle pointer in a mechanical meter cluster.

The display device 90 may manipulate indication of the light pointer 100, such as the width of the light pointer 100 and/or the length of the light pointer 100. The display device 90 may manipulate the area of the inner pointer source pixels 120P to modify the width of the light pointer 100. Specifically, the display device 90 may reduce the area of the inner pointer source pixels 120P to thin the light pointer 100 and may increase the area of the inner pointer source pixels 120P to widen the light pointer 100. The display device 90 may manipulate the intensity of the inner pointer source pixels 120P to control the length of the light pointer 100. Specifically, the display device 90 may reduce the intensity of the inner pointer source pixels 120P to shorten the light pointer 100 and may increase the intensity of the inner pointer source pixels 120P to elongate the light pointer 100. For example, the display device 90 may manipulate the width and/or the length of the light pointer 100 correspondingly to the vehicle speed, acceleration of the vehicle, fuel consumption of the vehicle, and/or the like. For example, as the vehicle accelerates and/or as the fuel consumption becomes better, the light pointer 100 may be indicated thinner or longer, and vice versa.

The dial conductor 60 may receive entirely lights in same intensity (e.g., same color), lights in similar intensities (e.g., similar color) to produce a color-gradation effect, and/or lights in different intensities (e.g., different color) to produce a color-separated effect.

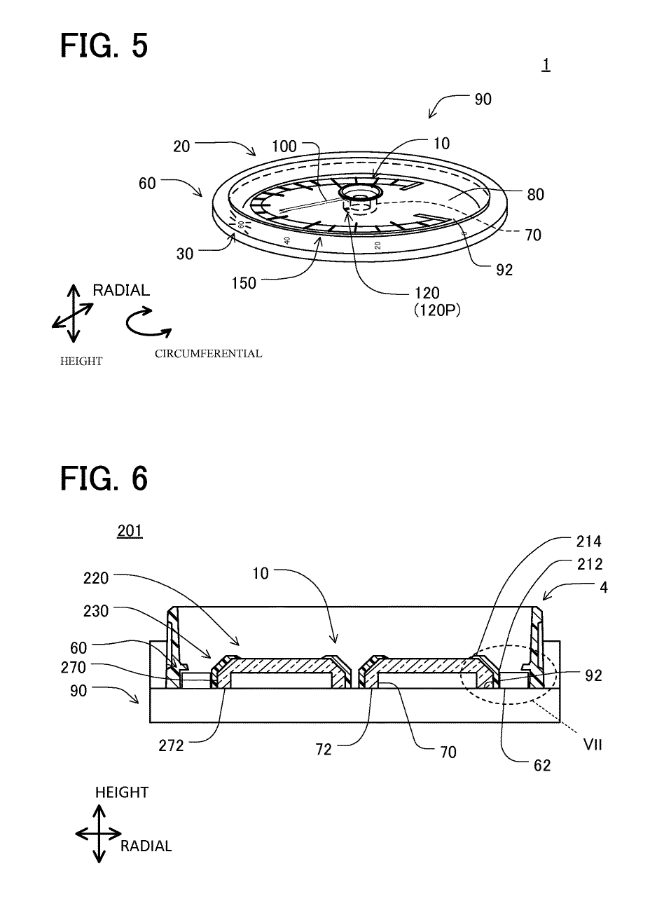

As shown in FIG. 5, the light pointer 100 extends from the center of the screen 92 linearly through the conductor disc 80. The light pointer 100 points a tickmark of the scale 150. The letter 30 directed by the light pointer 100 may be illuminated.

The screen 92 controls the intensity of the inner pointer source pixels 120P to indicate the light pointer 100 to extend to an intermediate portion relative to the scale 150. The screen 92 may control to reduce the intensity of the inner pointer source pixels 120P such that the tip end of the light point becomes blur.

### Second Embodiment

As shown in FIG. 6, a meter device 201 according to the second embodiment includes a radial conductor 220 and an opaque periphery 230. The radial conductor 220 includes the inner conductor body 70, the conductor disc 80, and an outer conductor body 270, which are integrally molded of a substantially transparent light-conductive material. The outer conductor body 270 is in a tubular shape extending in the height direction. The outer conductor body 270 has a conical top connected with the conductor disc 80. The conductor disc 80 is located on the inside of the conical top of the outer conductor body 270 in the radial direction. The outer conductor body 270 has an outer annular end surface 272 on the lower side. The outer annular end surface 272 is faced to the screen 92.

The opaque periphery 230 includes a periphery body 212 and a periphery disc 214, which are integrally molded of an opaque plastic material. The periphery body 212 is in a tubular shape extending in the height direction. The periphery body 212 has a conical top connected with the periphery disc 214. The periphery disc 214 is located on the inside of the conical top in the radial direction. The periphery disc 214 is in a disc shape extending in the circumferential direction. The periphery disc 214 is chamfered at its outer circumferential periphery to have a circular inclined surface faced upward in the drawing.

The opaque periphery 230 is further stacked together with the radial conductor 20 and, for example, is adhered on the display device 90.

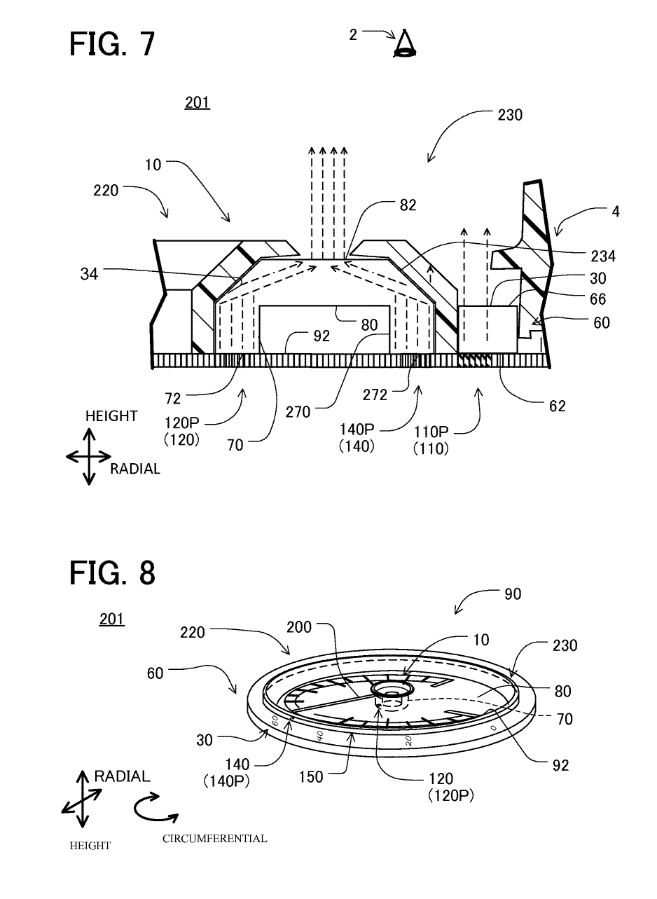

FIG. 7 shows one side of the meter device 201 encircled by VII in FIG. 6. For convenience of explanation, the entire structure of the meter device 201 is reduced in width in the radial direction.

The outer conductor body 270 further has a receiver reflection surface 234 inclined relative to the outer annular end surface 272. The receiver reflection surface 34 and the receiver reflection surface 234 are opposed to each other and may be at a right angel relative to each other. The outer conductor body 270 and the conductor disc 80 further form a bent light conduction passage. When viewed from the user 2 along the height direction, the outer annular end surface 272 is concealed by the opaque periphery 230.

The screen 92 further activates outer pointer source pixels 140P correspondingly to an outer pointer source 140. The outer pointer source pixels 140P emit light (third light) along the dotted arrow through the outer conductor body 270 and the conductor disc 80. Specifically, the light incident from the outer pointer source pixels 140P passes through the outer conductor body 270 along the height direction. The light is reflected on the receiver reflection surface 234 and directed inward in the radial direction to pass through the conductor disc 80.

The screen 92 is further configured to manipulate the positions of the outer pointer source pixels 140P along the outer annular end surface 272 in the circumferential direction. For example, the positions of the outer pointer source pixels 140P is moved in synchronous with the inner pointer source pixels 120P in the circumference direction. In this way, the light emitted from the outer pointer source pixels 140P and reflected on the receiver reflection surface 234 is directed linearly toward the light emitted from the inner pointer source pixels 120P and reflected on the receiver reflection surface 34. Thus, a light pointer 200 formed by the light emitted from the outer pointer source pixels 140P is bridged with the light emitted from the inner pointer source pixels 120P.

As shown in FIG. 8, the outer pointer source pixels 140P may form a sector shape, a rectangular shape, or a circular shape to control the shape and/or convergence of the light pointer 200. The conductor disc 80 conducts light from the radially outer side toward the center and further conducts light from the radially inner side toward the radially outer side thereby to bridge the light within the conductor disc 80 to form the light pointer 200.

### Third Embodiment

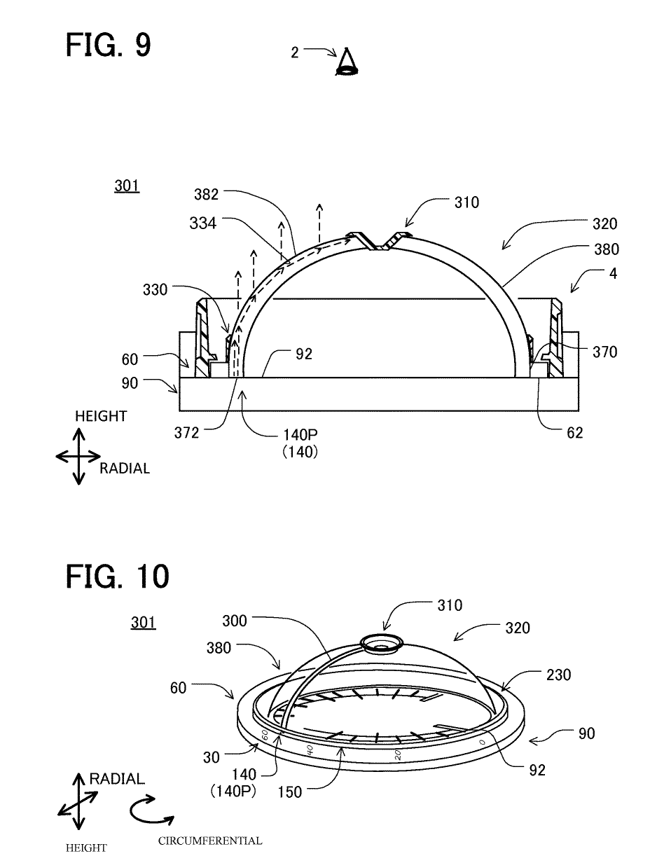

As shown in FIG. 9, a meter device 301 according to the third embodiment includes a radial conductor 320 including a conductor dome (projection conductor) 380 and an outer conductor body, which are integrally molded of a substantially transparent light-conductive material. The conductor dome 380 is in a hemispherical dome shape. The conductor dome 380 extends continually in the circumferential direction. An outer conductor body 370 is in a tubular shape. The outer conductor body 370 has an outer annular end surface 372 on the lower side in FIG. 9. The outer annular end surface 372 is faced to the screen 92.

An opaque center 310 is molded of an opaque plastic material in a conical cup shape. The opaque center 310 is equipped to a mounting hole formed in the center of the conductor dome 380. An opaque periphery 330 is further stacked together with the conductor dome 380 and, for example, adhered on the dial conductor 60 and or the conductor dome 380. The conductor dome 380 further has a receiver reflection surface 334 being a hemispherical surface. The receiver reflection surface 334 is curved along the surface of the conductor dome 380. That is, the receiver reflection surface 334 continually varies in inclination angle relative to the outer annular end surface 372.

The conductor dome 380 forms a curved light conduction passage. When viewed from the user 2, the outer annular end surface 372 may be concealed by the opaque periphery 330.

The display device 90 activates the outer pointer source pixels 140P correspondingly to the outer pointer source 140. The outer pointer source pixels 140P emit light (third light) along the dotted arrow through the conductor dome 380.

The light incident from the outer pointer source pixels 140P first passes through the conductor dome 380 along the height direction. The light may be partially reflected on the receiver reflection surface 334 and directed inward in the radial direction to pass through the conductor dome 380. Simultaneously, the light may partially illuminate the receiver reflection surface 334 to cause illumination viewable by the user 2.

The light may repeat the reflection and the illumination while advancing inward in the radial direction toward the center of the conductor dome 380. In this way, the light illuminates the receiver reflection surface 334 to extend linearly in the radial direction toward the center. Thus, the light forms a linear illumination viewable as a light pointer 300 by the user 2.

The screen 92 may manipulate the positions of the outer pointer source pixels 140P along the outer annular end surface 372 in the circumferential direction thereby to move the light pointer 300 in the circumference direction.

As shown in FIG. 9, the outer pointer source pixels 140P may form a sector shape, a rectangular shape, or a circular shape to control the shape and/or convergence of the light pointer 300. The light pointer 300 may extend linearly when being viewed from the user 2 at a position perpendicular to the screen 92 and may be curved when being viewed from a position at an angle relative to the screen 92. The opaque center 310 may terminate the light pointer 300 at its periphery and may restrict the light pointer 300 from extending to the radially opposite side.

### Fourth Embodiment

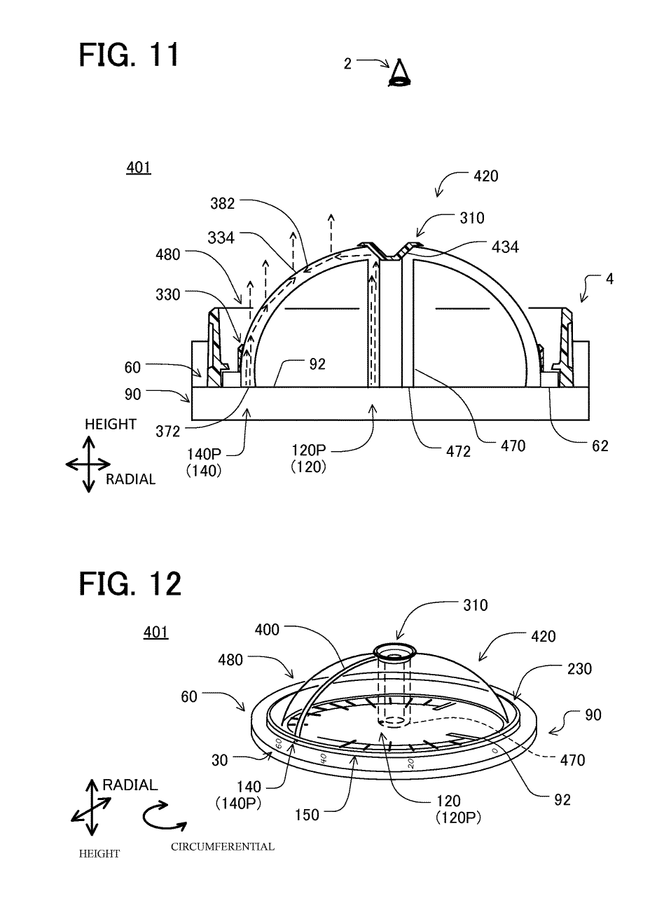

As shown in FIG. 11, a meter device 401 according to the fourth embodiment includes a conductor dome 480, which has a similar structure to the conductor dome 380 of the third embodiment. The conductor dome 480 further has an inner conductor body 470. The inner conductor body 470 is in a tubular shape and has an inner annular end surface 472 on the lower side. The inner annular end surface 472 is faced to the screen 92. The inner conductor body 470 has a receiver reflection surface 434 inclined relative to the inner annular end surface 472.

The screen 92 further activates the inner pointer source pixels 120P correspondingly to the inner pointer source 120. The inner pointer source pixels 120P emit light (first light) along the dotted arrow through the inner conductor body 470. The light is reflected on the receiver reflection surface 434 and is directed outward in the radial direction toward the dome projection surface 382.

As shown in FIG. 12, the inner pointer source pixels 120P may form a sector shape, a rectangular shape, or a circular shape to control the shape and/or convergence of a light pointer 400. The conductor disc 80 conducts light from the radially outer side toward the center and further conducts light from the radially inner side toward the radially outer side thereby to bridge the light linearly within the conductor disc 80. Thus, the light pointer 400 formed by the light emitted from the outer pointer source pixels 140P is bridged with the light emitted from the inner pointer source pixels 120P.

### Other Embodiment

In the first embodiment, the light may be emitted from the center outward in the radial direction to form the light pointer. In the third embodiment, the light may be emitted from the radially outside inward in the radial direction to form the light pointer.

The radial conductor and the conductor dome are not limited to an integrally formed single piece and may be constructed of multiple components into a single piece.

The dial conductor may be located inside the radial conductor or the conductor dome in the radial direction.

The description is merely illustrative in nature and is in no way intended to limit the disclosure, its application, or uses. For purposes of clarity, the same reference numbers will be used in the drawings to identify similar elements. The phrase at least one of A, B, and C should be construed to mean a logical (A or B or C), using a non-exclusive logical or.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A light conductor device configured to receive light from a light source, the light conductor device comprising:
a radial conductor including a conductor body and a projection conductor, wherein
the conductor body has an annular end surface,
the projection conductor has a projection surface,
the conductor body is configured to receive light from the light source though the annular end surface, and
the conductor body is further configured to conduct the light in a radial direction to illuminate the projection surface in the radial direction and to form a light pointer on the projection surface.

2. The light conductor device according to claim 1, wherein
the conductor body is in a tubular shape, and
the conductor body is further configured to conduct the light in a height direction and to conduct the light in the radial direction toward the projection surface.

3. The light conductor device according to claim 1, wherein the light pointer extends on the projection surface linearly in the radial direction.

4. The light conductor device according to claim 1, wherein
the conductor body includes an inner conductor body located inside the projection conductor in the radial direction,
the inner conductor body has an inner annular end surface, and
the inner conductor body is configured to receive light emitted though the inner annular end surface and to conduct the light to the projection conductor outward in the radial direction.

5. The light conductor device according to claim 1, wherein
the conductor body includes an outer conductor body located outside the projection conductor in the radial direction,
the outer conductor body has an outer annular end surface, and
the outer conductor body is configured to receive light emitted though the outer annular end surface and to conduct the light to the projection conductor inward in the radial direction.

6. The light conductor device according to claim 1, wherein
the conductor body includes both an inner conductor body and an outer conductor body,
the inner conductor body is located inside the projection conductor in the radial direction,
the inner conductor body has an inner annular end surface,
the inner conductor body is configured to receive light emitted though the inner annular end surface and to conduct the light to the projection conductor outward in the radial direction,
the outer conductor body is located outside the projection conductor in the radial direction,
the outer conductor body has an outer annular end surface, and
the outer conductor body is configured to receive light emitted though the outer annular end surface and to conduct the light to the projection conductor inward in the radial direction.

7. The light conductor device according to claim 1, wherein
the projection conductor includes a disc conductor in a disc shape, and
the disc conductor defines the projection surface in a flat surface.

8. The light conductor device according to claim 7, wherein
the conductor body has a receiver reflection surface opposed to the annular end surface, and
the receiver reflection surface is configured to reflect light incident through the annular end surface toward the projection surface.

9. The light conductor device according to claim 1, wherein
the projection conductor includes a conductor dome in a dome shape, and
the conductor dome defines the projection surface in a hemisphere surface.

10. The light conductor device according to claim 9, wherein
the projection surface is at least partially opposed to the annular end surface, and
the projection surface is configured to reflect a part of light incident through the annular end surface inward in the radial direction while permitting a part of the light to pass therethrough.

11. The light conductor device according to claim 1, further comprising:
a dial conductor in a disc shape and located coaxially with the radial conductor, wherein
the dial conductor has a letter configured to be pointed by the light pointer.

12. The light conductor device according to claim 1, wherein the dial conductor is configured to conduct light therethrough to illuminate the letter.

13. A meter device comprising:
a light source; and
a radial conductor configured to receive light from the light source, wherein
the radial conductor includes a conductor body and a projection conductor,
the conductor body has an annular end surface,
the projection conductor has a projection surface,
the conductor body is configured to receive light from the light source though the annular end surface,
the conductor body is further configured to conduct the light in a radial direction to illuminate the projection surface in the radial direction and to form a light pointer on the projection surface, and
the light source is configured to move the light along the annular end surface to rotate the light pointer on the projection surface.

14. The meter device according to claim 13, wherein
the light source has a plurality of pixels configured to be activated selectively,
the radial conductor is stacked on the light source,
the conductor body is configured to receive light from the pixels, and
the light source is configured to activate the pixels along the annular end surface to move the light.
